(19) United States
(12) Patent Application Publication
(10) Pub. No.: US 2013/0114882 A1
(43) Pub. Date: May 9, 2013

(54) SYSTEM, DEVICE, AND METHOD FOR ASSISTING VISUAL CHECK OPERATION OF INSPECTION RESULT

(71) Applicant: OMRON Corporation, Kyoto (JP)

(72) Inventor: Akihiro Kawata, Kawanishi-shi (JP)

(73) Assignee: OMRON CORPORATION, Kyoto (JP)

(21) Appl. No.: 13/657,008

(22) Filed: Oct. 22, 2012

(30) Foreign Application Priority Data
Nov. 7, 2011 (JP) 2011-243589

(51) Int. Cl. G06K 9/62

(52) U.S. Cl. 382/150

(57) ABSTRACT

With regard to a target (board) to which an automatic appearance inspection is completed, an image used in the inspection is stored, measurement data obtained by measurement processing in the inspection is stored in association with positional information of a measurement target region, and by using these pieces of stored information, an image for assisting an operation of visually checking an actual state of a specific inspection target region is displayed. This image corresponds to an area equivalent to a part of the board, and includes the checking target component. For the checking target component in the image, marking by a frame UW and lines L1 and L2 is implemented. Moreover, feature regions which are visually recognizable and have intrinsic features are extracted so as to surround a periphery of the checking target component.

### BACKGROUND OF THE INVENTION

1. Technical Field

The present invention relates to a system for assisting an operation of checking an inspection result, which is obtained by an automatic appearance inspection using an image, by visually recognizing an actual inspection target, relates to a device for the assistance, and relates to a method for the assistance.

2. Related Art

In a manufacturing site of component-mounted boards, presence of components, a state of solder fillets, and the like are inspected by an automatic appearance inspection device, and thereafter, an operator visually checks components, which are determined to be defective, finally. Moreover, for components which are correctable among the components defined to be defective, the operator may manually correct the components while checking the states thereof.

As a conventional example of a device that performs such an operation of visually recognizing defective spots, there is a device in which a magnifying glass is arranged above a stage that supports each of the boards as inspection targets. With regard to this device, for example, Japanese Unexamined Patent Publication No. 2001-165860 describes that, by acquiring position information of the spot determined to be defective from the appearance inspection device and controlling a motion of the stage based on this position information, a spot determined to be defective is located at a center of a field of view of the magnifying glass.

Japanese Unexamined Patent Publication No. H08-195554 discloses a device for a correction operation of a soldering defective spot, the device including a magnifying glass, an XY table, a laser light source, and the like. In this device, a laser beam is irradiated onto the field of view of the magnifying glass, and the defective spot is aligned with an irradiated position of the laser beam based on position data of the defective spot, which is obtained from a soldering inspection device, whereby a defective region is pointed out explicitly.

In a site of manufacturing boards required to ensure high quality, such a system is adopted, in which an inspection standard of the automatic appearance inspection is strictly set, and the operator visually checks the components with care, which are determined to be defective, manually corrects the defective spots, and carefully checks that the defects are eliminated. In the component-mounted boards in recent years, a mounting density of the components is high, and accordingly, the number of components for which the visual check and correction are required is also increased, and efforts of the operator who performs the visual check becomes enormous. In addition, since there are many boards mounted with the same type of components on a plurality of spots, and boards to which a plurality of individual boards with the same configuration are coupled with one another, an extremely large load is required to find a region as a checking target. Furthermore, a person who is not accustomed to the operation may make a mistake in finding such a checking target region.

In accordance with the devices with such configurations as described in Japanese Unexamined Patent Publication Nos. 2001-165860 and H08-195554, defective spots of real objects are displayed while being enlarged or identified, and accordingly, the operation load can be reduced, and the mistake can be prevented. However, scales of both of the devices are large, and cost thereof is high. Moreover, the fact that a wide space is necessary for installation of each of the devices also hinders introduction thereof.

Besides, there is also conceived a method of notifying the checking target region in such a manner that a partial range, which has a defective spot as a center, is cut out from an image of the inspection target board, which is used for the automatic appearance inspection, and that an enlarged image of this range is then displayed. However, as described above, each of the boards has the plurality of spots having a similar configuration. Accordingly, only the display of the image of the range having the defective spot as the center is insufficient for instantaneously specifying to which spot of the actual board the defective spot corresponds. As a result, operation efficiency of the operator may be lowered, which may result in a large influence also on the entire production efficiency.

### SUMMARY

In consideration of the foregoing problems, it is an object of the present invention to perform assistance capable of easily specifying a checking target region by using an image for use in an automatic appearance inspection, and using an inspection result.

A system for assisting a visual check operation according to the present invention is a system for assisting an operation of checking a state of at least one inspection target region of an inspection target having a plurality of regions to which an automatic appearance inspection using an image is performed, the operation being performed by a method of visually recognizing an actual inspection target. The system includes an image storage unit, a measurement data storage unit, an image reading unit, a feature region extraction unit, an image editing unit, and a display unit, which will be described blow.

The image storage unit stores an image of the inspection target, which is created by imaging for the automatic appearance inspection, and the measurement data storage unit stores measurement data obtained by measurement processing of the automatic appearance inspection in association with positional information of a target region measured by the measurement processing. The image reading unit reads out an image of an area, which includes a checking target region and corresponds to a part of the inspection target, from the image storage unit based on positional information or identification information of the checking target region.

The feature region extraction unit analyzes the measurement data stored in the measurement data storage unit in association with the positional information included in the area corresponding to the image read out by the image reading unit, and extracts one or more feature regions which have intrinsic features individually visually recognizable and are distributed near the checking target region. The image editing unit edits the image read out by the image reading unit to a state where the respective feature regions and the checking target region in the image are marked in modes different from each other, and the display unit displays the image edited by the image editing unit.

In accordance with the above-described configuration, an operator can check which region is the checking target based on a mark in a displayed screen, and in addition, can specify a checking target region of the actual inspection target based on features of the plurality of feature regions distributed near the checking target region and from a relative positional relationship thereamong. Each of the feature regions has an intrinsic feature that is visually recognizable, and accordingly, even if there are other spots with similar configurations, the checking target region can be prevented from being mistaken.

In a first embodiment of the above-described system, by using, as a key, a degree of deviation of a measurement value obtained in the measurement processing of the automatic appearance inspection with respect to an optimum measurement value, the feature region extraction unit extracts a region with a relatively large degree of deviation among inspection target regions other than the checking target region, which are included in an area of a processing target. For example, if a region, which is determined to be non-defective in the automatic appearance inspection, but in which a measurement value used in such determination is largely deviated from an optimum value, is extracted as the feature region, even if there are other spots where the same types of regions as the checking target region and the respective feature regions are arranged with a similar positional relationship, then it becomes possible to distinguish the extracted feature region by the appearance thereof.

In a system of a second embodiment, measurement for detecting a foreign object located at a place other than the inspection target region is included in the measurement processing of the automatic appearance inspection, and the feature region extraction unit extracts, as the feature region, a spot where measurement data indicating the foreign object is obtained near of the checking target region in the area as the processing target. In this way, the operator can easily specify the checking target region by using the foreign object as a mark. Note that it is also possible to arrange a system into which both of the first embodiment and the second embodiment are incorporated.

A system of a third embodiment further includes a mark pattern storage unit that stores information for specifying a mark pattern set as a mark in the automatic appearance inspection commonly to an identical type of the inspection target. The image editing unit specifies a place of the mark pattern included in the area as the processing target based on the information stored in the mark pattern storage unit, and edits the image so that the specified place is marked in a mode different from that of at least the checking target region.

In accordance with the above embodiment, the place of the mark pattern is marked as well as the feature region, and accordingly, the checking target region can be specified more easily. Note that, for the mark pattern, marking according to a third mode different from those of the marking for both of the checking target region and the feature regions is desirably implemented; however, marking according to the same mode as that for the feature regions may be implemented.

The above-described system can include a server that receives, by communication with an appearance inspection device, inspection result information including the image used in the appearance inspection and the measurement data, and can include a terminal device having a display unit for the check operation. In this case, at least the image storage unit and the measurement data storage unit are provided in the server, and the display unit of the terminal device functions as the display unit. Other units may be provided in any of the server and the terminal device, or a part of the units may be provided in the server, and the rest of units may be provided in the terminal device. Alternatively, the server and the terminal device may be allowed to function as one unit in cooperation with each other.

The image storage unit and the measurement data storage unit can be provided not only in the server but also in the appearance inspection device. Moreover, distinction between the server and the terminal device may be eliminated, and the respective units, i.e., the image storage unit, the measurement data storage unit, the image reading unit, the feature region extraction unit, the image editing unit, and the display unit may be provided in a single computer.

A device for assisting a visual check operation according to the present invention includes at least the image reading unit, the feature region extraction unit, and the image editing unit among the above-described respective units, and further includes an output unit that outputs image data of the image edited by the image editing unit such that the image data is displayed. Moreover, the image storage unit and the measurement data storage unit can be provided in such an assisting device; however, these storage units may be provided in an external computer or the appearance inspection device.

A method for assisting a visual check operation of an inspection result according to the present invention includes the steps of: storing an image of an inspection target, the image being created by imaging for automatic appearance inspection, in an image storage unit in response to the automatic appearance inspection, and storing measurement data, which is obtained by measurement processing in the automatic appearance inspection, in a measurement data storage unit in association with positional information of a target region measured by the measurement processing; reading out an image of an area from the image storage unit based on positional information or identification information of a checking target region, the area including the checking target region and corresponds to a part of the inspection target; analyzing measurement data, the measurement data being stored in the measurement data storage unit in association with positional information included in the area corresponding to the image read out from the image storage unit, and extracting one or more feature regions which have intrinsic features individually visually recognizable and are distributed near the checking target region; and editing the image read out from the image storage unit to a state where the respective feature regions and the checking target region in the image are marked in modes different from each other, and displaying the edited image.

The above method can be implemented by the combination of the server and the terminal device or by the single computer, which has been described above. Moreover, when the image storage unit and measurement data storage unit are provided in the appearance inspection device, and further, when the display unit is incorporated in the appearance inspection device, then the above method may be implemented in the appearance inspection device.

Moreover, among the respective steps, with regard to the step of reading out an image and the step of extracting feature regions, any of the above steps may be executed first, and both of the steps may be executed in parallel.

The target region of the visual check is not limited to the region determined to be defective in the appearance inspection. For example, such a region, which is determined to be non-defective in the appearance inspection, but in which a degree of deviation of the measurement value from the optimum value thereof is large, may be treated as the checking target region. Moreover, a region having an important function may always be set as the target region of the visual check for the purpose of double check.

Moreover, with regard to which region is to be checked, for example, the checking target region may be automatically selected by analysis of the inspection result and the measurement result, or a list of regions for which the check is supposed to be necessary may be displayed, and the operator may be allowed to select the region therefrom.

In accordance with the present invention, based on the marking features in the display screen, the spot in the actual inspection target, which corresponds to the marked spot, can be easily identified, whereby the checking target region can be specified. Hence, it becomes possible to efficiently proceed the visual check operation without making a mistake in finding the checking target region.

### BRIEF DESCRIPTION OF THE DRAWINGS

FIG. 1 is a functional block diagram showing a configuration of a system for inspecting a component-mounted board;

FIG. 2 is a layout diagram of a check screen for checking information of a defective component;

FIG. 3 is a view showing an example of an image to be displayed on an area 300 of FIG. 2;

FIG. 4 is a flowchart showing a procedure of a check operation;

FIG. 5 is a table showing a data configuration example of an analysis data table;

FIG. 6 is a flowchart showing a procedure of creation processing of the analysis data table; and

FIG. 7 is a flowchart showing a procedure of processing to be executed in a check terminal.

### DETAILED DESCRIPTION

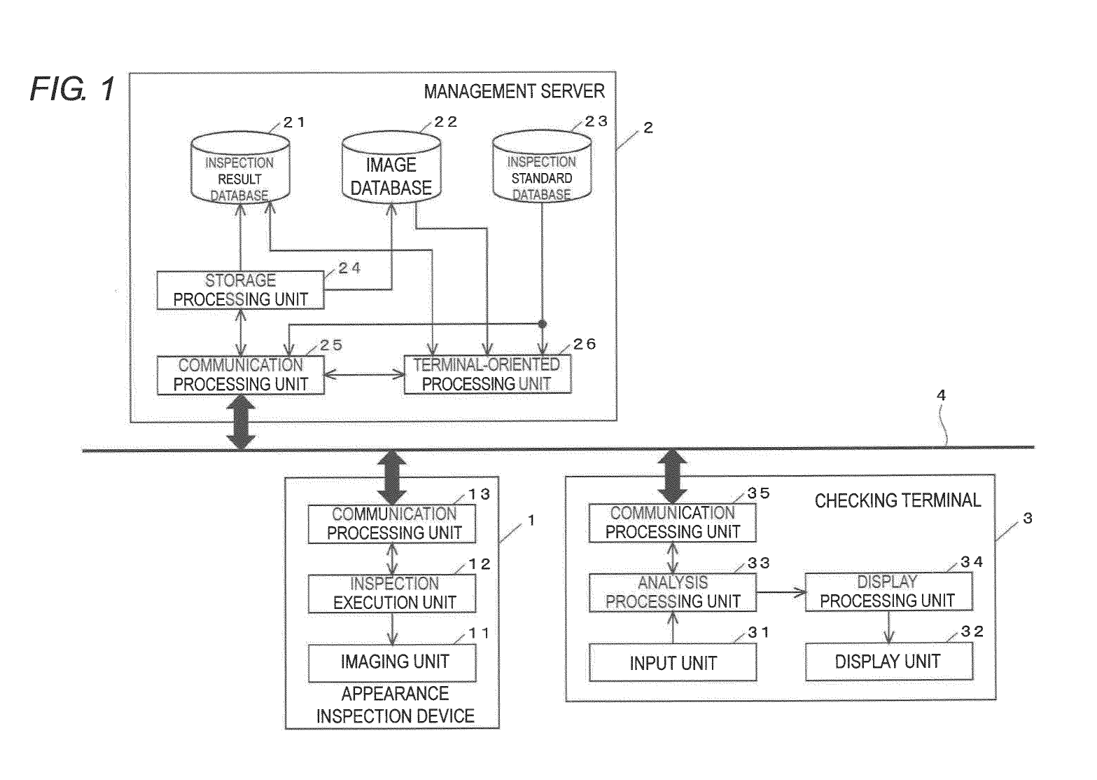

FIG. 1 is a functional block diagram showing a configuration example of a system for inspecting a component-mounted board.

This embodiment is an embodiment of performing an automatic appearance inspection for an object that is a component-mounted board (hereinafter, simply referred to as a “board”) completed through the respective steps, i.e., a solder printing step, a component mounting step, and a reflowing step, and thereafter, allowing an operator to visually check a region determined to be defective by the inspection. This embodiment includes an appearance inspection device 1, a management server 2, and a terminal device 3 for check operation (hereinafter, referred to as a “checking terminal 3”). The respective devices 1, 2 and 3 are connected to one another through a LAN line 4; however, the checking terminal 3 and the appearance inspection device 1 do not directly communicate with each other, and the appearance inspection device 1 and the management server 2 exchange information therebetween, and the checking terminal 3 and the management server 2 exchange information therebetween. A network system including the management server 2, the checking terminal 3, and the LAN line 4 functions as a system for assisting such a visual check operation.

The appearance inspection device 1 includes an imaging unit 11, an inspection execution unit 12, a communication processing unit 13, and the like. In accordance with a predetermined inspection standard, the inspection execution unit 12 actuates the imaging unit 11 to create an image, and by using the created image, inspects, for each of components, whether or not the component is mounted on the board, whether or not the component is positionally shifted or rotationally shifted, whether or not a shape and size of a solder fillet are suitable, and so on. Moreover, the inspection execution unit 12 may detect foreign objects such as bridges and solder balls from a place in an image, on which the component is not mounted. Images used in a variety of the inspections and inspection result information are transmitted from the communication processing unit 13 to the management server 2.

In the management server 2, such functions are provided, which are: a storage unit including an inspection result database 21, an image database 22, an inspection standard database 23, and the like; a storage processing unit 24; a communication processing unit 25; and a terminal-oriented processing unit 26. Information transmitted from the appearance inspection device 1 is received by the communication processing unit 25, and thereafter, is stored in the inspection result database 21 and the image database 22 by the storage processing unit 24.

In the inspection standard database 23, inspection standards for appearance inspections are registered for each type of the boards. For example, as component-unit inspection standards, there are registered configuration data of inspection areas, threshold values for binarization, and the like, and further, ranges of measurement values, which indicate “non-defective”, are registered for each of measurement items to be implemented for the components. Also with regard to the detection of the foreign objects, binarization threshold values for use in the detection, threshold values to be compared with measurement values regarding detected features, and the like are registered as inspection standards.

Moreover, in this embodiment, one board is imaged a plurality of times, and an image of the whole board is created by connecting images, which are imaged the plurality of times, to one another. A group of information for use in control to align a field of view of the imaging unit 11 with the respective imaging target areas, and a group of information for use in processing for connecting the images to one another are also stored in the inspection standard database 23. The group of information for use in processing includes information for specifying a pattern serving as a mark on the board (hereinafter, referred to as a “mark pattern”).

The inspection result information to be transmitted from the appearance inspection device 1 is layered so that the measurement values and defective/non-defective determination results can be read out for each of the boards and for each of the components in the boards. In the case where such information of the defects is contained in such board-unit inspection result information, the storage processing unit 24 analyzes the inspection result information, and creates an analysis data table to be described later. The analysis data table is configured so as to be readable for a unit of the boards, and is stored in the inspection result database 21 in association with the inspection result information as original information.

The terminal-oriented processing unit 26 receives a transmission request, which comes from the checking terminal 3, through the communication processing unit 25, reads out information according to the request from the corresponding database, and transmits the information to the checking terminal 3. Moreover, upon acquiring, from the checking terminal 3, such inspection result information containing determination data inputted by the operator who has performed the operation on the checking terminal 3, the terminal-oriented processing unit 26 updates the existing inspection result information in the inspection result database 21 with the acquired information.

The inspection standards in the inspection standard database 23 are also transmitted to the appearance inspection device 1 according to needs.

The checking terminal 3 includes an input unit 31, a display unit 32, an analysis processing unit 33, a display processing unit 34, a communication processing unit 35, and the like. The input unit 31 and the display unit 32 include hardware, and the other processing units are functions to be set in a CPU by software.

The input unit 31 is a unit for receiving input of identification codes of the boards as checking targets (hereinafter, referred to as “board codes”), check results, and the like, and can include a reading device (a bar code reader and the like) of the board codes, as well as a keyboard and a mouse. The display unit 32 includes a configuration such as a liquid crystal monitor, which is capable of displaying an image. Note that, in some cases, the display unit 32 is positioned as an external device of the checking terminal 3.

The analysis processing unit 33 is activated in response to the input of each of the board codes, thereafter communicates with the management server 2 through the communication processing unit 35, and for the board corresponding to the inputted board code, acquires the respective pieces of information, i.e., the image, the inspection result information, and the inspection standard. Based on a processing result by the analysis processing unit 33, the display processing unit 34 creates data of a check screen for checking information regarding the component determined to be defective in the appearance information (hereinafter, referred to as a “defective component), and displays this check screen on the display unit 32.

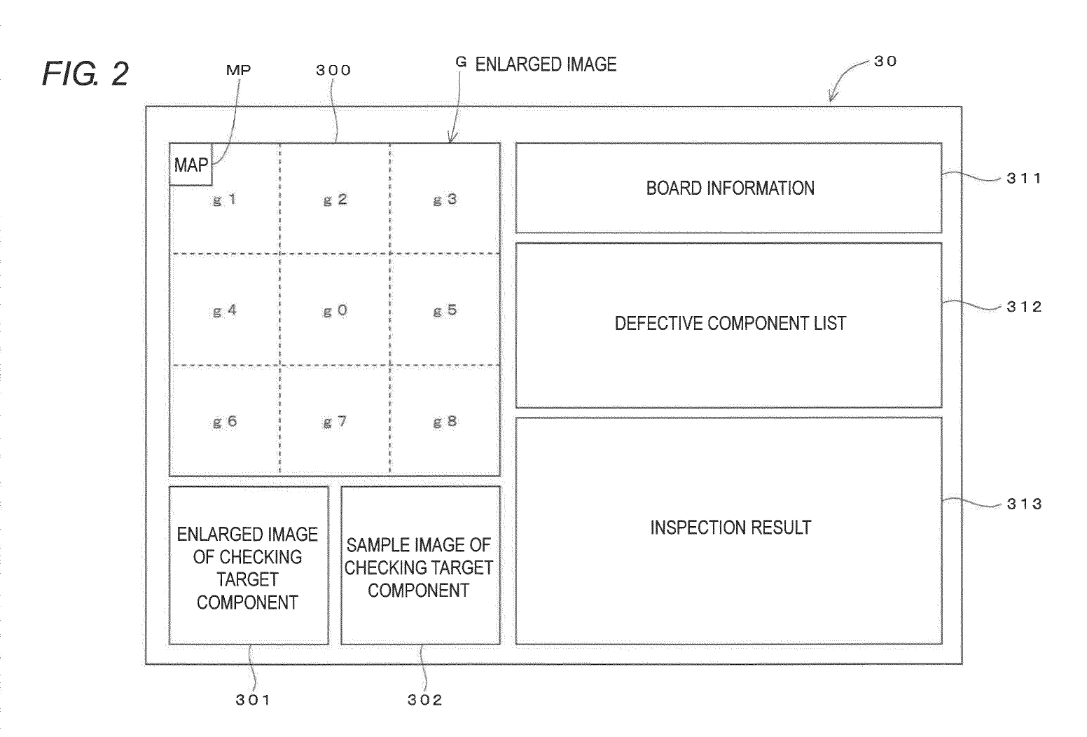

FIG. 2 shows an example of a layout of the check screen.

On the check screen of this example, an image and information other than the image are displayed on left and right sides thereof, respectively. First, on a left-side area that displays the image, a large area 300 is provided, and two small areas 301 and 302 are arranged side by side on the left and right below the area 300.

On the area 300, an enlarged image of a range (a part of the board) in which the component as each of the checking targets is centered is displayed. On an upper left corner of this enlarged image G, a map image MP of the whole board is displayed in an overlapping manner. On the area 301, an image of a range only including such a checking target component is displayed further enlargedly, and on the area 302, a sample image (showing an ideal mounting state) of the checking target component is displayed.

As mentioned above, in the appearance inspection of this embodiment, one board is imaged after being divided into a plurality of areas, and images created by imaging the plurality of areas (hereinafter, referred to as “divided images”) are connected to one another, whereby the image of the whole board is created. The enlarged image G on such a check screen 30 is also created by connecting a divided image g0 including the component as the checking target and eight divided images g1 to g8 near a periphery thereof.

Meanwhile, the map image MP is an image created not by imaging the board under processing but by imaging a board as a model in advance, or is a schematic view by CAD data and the like. The map image MP is an image for allowing the operator to obtain an approximate position of the checking target component in the whole board, and the enlarged image G is an image for notifying the operator of detailed configurations of the checking target component and the periphery thereof.

On the right side of the screen, three areas 311, 312 and 313 are arranged vertically. On the uppermost area 311, general information (the board code, a program name indicating the inspection standard, the number of defective components, and the like) regarding the board as the checking target is displayed. On the center area 312, a list of the defective components to be checked is displayed. On the lowermost area 313, inspection results regarding components as current checking targets are displayed together with measurement values for each of measurement items.

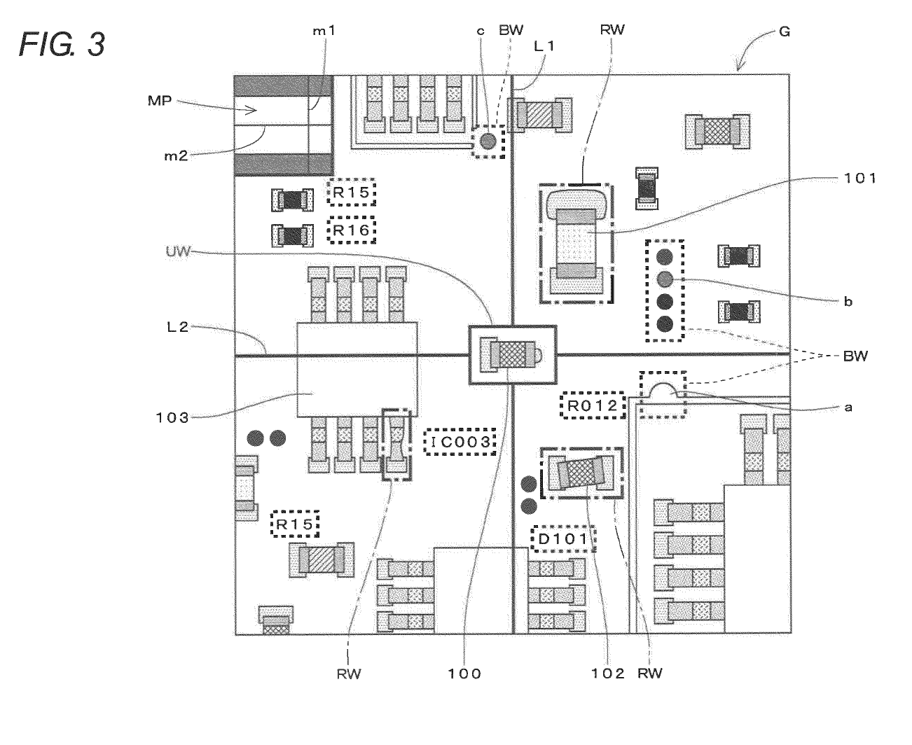

FIG. 3 shows a specific example of the enlarged image G and the map image MP in the area 300. A component 100 located at a center portion of the enlarged image G is the checking target component of this example.

The map image MP includes back ground portions (gray portions, which are actually colored with a color of a surface of a stage on which the board is supported), as well as the entire image (a hollow portion) of the board. Although not shown in FIG. 3, on the board in the map image MP, the variety of components on the board are displayed in a reduced manner. Moreover, on the map image MP of this embodiment, two lines m1 and m2, which indicate an X-coordinate and Y-coordinate of a center of the checking target component, respectively, are displayed with a high-brightness color such as yellow and white.

Also on the enlarged image G, two lines L1 and L2, which indicate X- and Y-coordinates of the checking target component 100, respectively, are set by the same color as that of the lines m1 and m2. However, these lines L1 and L2 are not set on a mounting range of the checking target component 100, and the checking target component 100 is surrounded by a rectangular frame UW having the same color as that of the lines L1 and L2.

Moreover, on the enlarged image G, a plurality of red frames RW and a plurality of blue frames BW are set (in FIG. 3, the red color is expressed by alternate long and short dashed lines, and the blue color is expressed by dotted lines). Hereinafter, these color frames RW and BW are referred to as “red frames RW” and “blue frames BW”, respectively.

The red frames RW are set for those selected from structures such as the components and electrode pins, to which the appearance inspection is performed. In the example of FIG. 3, the red frames RW are individually set for a relatively large chip component 101 located above the checking target component 100, a relatively small chip component 102 located at a lower right region thereof, and an IC component 103 located at a lower left region thereof. Each of these components is determined to be “non-defective” in the appearance inspection. However, in the chip component 101, a solder area for one of electrodes becomes a little larger, and the chip component 102 is mounted while being inclined a little. Moreover, an electrode pin of the IC component 103, which is surrounded by the red frame, has a slightly distorted shape.

The blue frames BW are set for patterns used as marks in the case where processing such as correction of the positional shift of the image and positional alignment of the respective divided images is performed in the appearance inspection. These mark patterns are patterns specified by the positional information and shapes of the patterns, and the respective pieces of specifying information are registered in the inspection standard database 23 of the management server 2. In the example of FIG. 3, the blue frames BW are set to individually surround a protruding portion a of a silk printing pattern on the board, an array b of through holes, and a through hole c of a corner portion of the silk printing pattern, as well as character patterns indicating component codes of such mounted components.

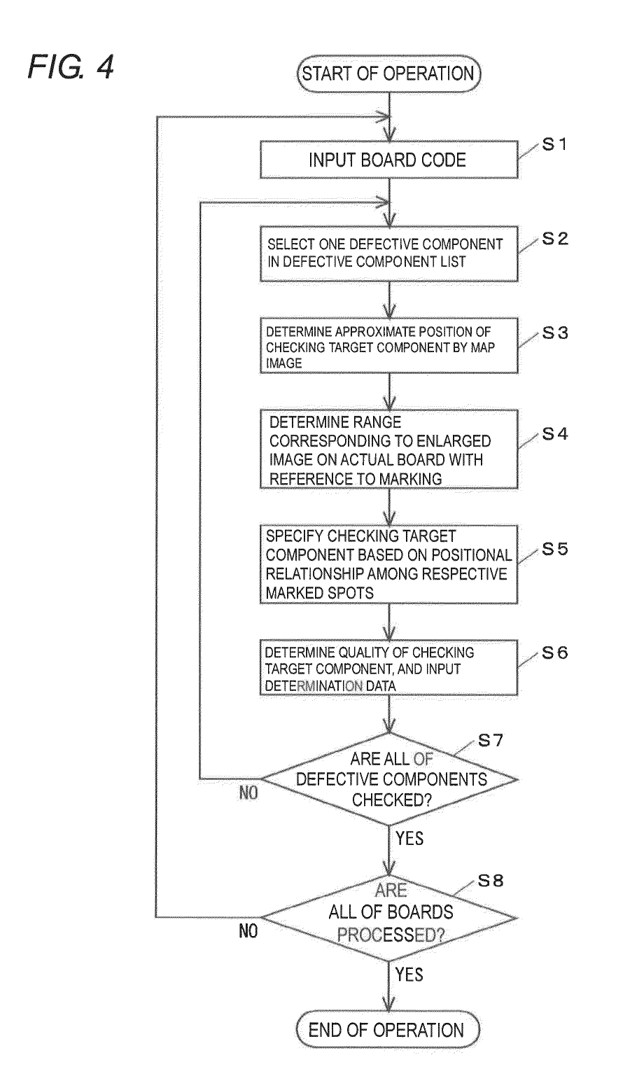

Such a board determined to have the defective component by the inspection by the appearance inspection device 1 is housed in a stacker, conveyed by a conveyor, and so on, and is thereby supplied to the operator who sits in front of the checking terminal 3. The operator executes the check operation in such a procedure as shown in FIG. 4 while looking at the check screen including the above-described enlarged image G and map image MP.

First, the operator picks up one board, and inputs a board code thereof to the checking terminal 3 (step S1). On the board of this embodiment, a bar code indicating the board code is printed on a margin or the like of an end edge thereof, and accordingly, the board code can be inputted by reading processing using the bar code reader.

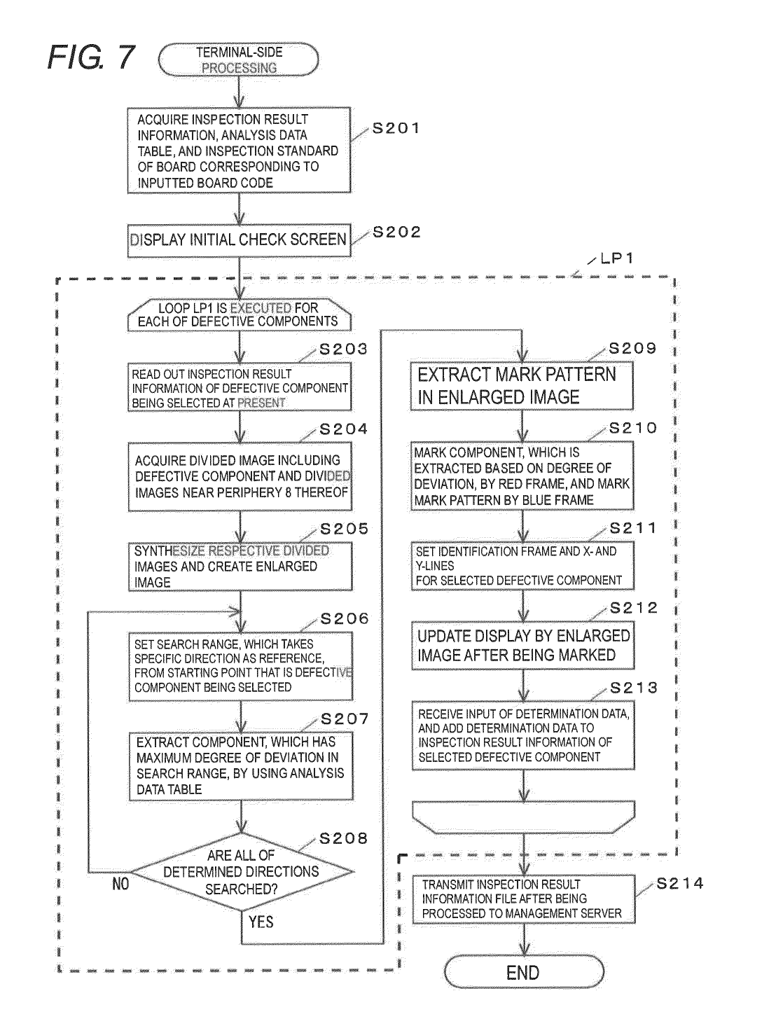

The checking terminal 3 communicates with the management server 2 in response to the input of the board code, acquires the inspection result information and inspection standard of the target board, and based thereon, starts up an initial check screen (step S202 of FIG. 7 to be described later). At this stage, the enlarged image G is not displayed on the area 300, and only the map image MP, which does not have the lines m1 and m2, is displayed thereon. Moreover, although the areas 301, 302, and 313, which display the image and information of the checking target component, also turn to a blank state, the board information and the list of the defective components on the areas 311 and 312 are displayed.

The operator checks the display of such a defective component list, and selects one defective component in the list (step S2). In response to this selection, in the checking terminal 3, steps S203 to S212 of FIG. 7 are implemented, the enlarged image G as shown in FIG. 3 is displayed on the left area 300 of the check screen, and the lines m1 and m2, which indicate a position of the selected component, are set on the map image MP on the upper left corner of the area 300. The enlarged image and the sample image of the selected component are displayed on the two areas 301 and 302 below the area 300, respectively, and the inspection result for the selected component is displayed on the lower right area 313.

The operator determines the approximate position of the checking target component by the lines m1 and m2 in the map image M (step S3). Next, the operator determines a range of the actual board, which corresponds to the enlarged image G, with reference to the features and distribution of the variously marked components and mark patterns of the enlarged image G (step S4). Moreover, the operator specifies the checking target component based on a positional relationship among the respective marked spots, and the like (step S5).

Thereafter, the operator visually checks the actual checking target component, determines quality thereof, and inputs determination data (OK or NG) (step S6).

In the case where the defective components remain in a first defective component list (“NO” in step S7), the operator selects the next component (returns to step S2), and thereafter continues the operation in a similar manner. In the case where all of the defective components are checked, and there is another board as the checking target (“NO” in step S8), the operator picks up the next board, and executes an operation similar to the above.

As mentioned above, the information for specifying the mark patterns surrounded by the blue frames BW is stored in the inspection standard database 23 of the management server 2. Meanwhile, the components and the electrodes, which are surrounded by the red frames RW, are specified by using the analysis data table in the inspection result database 21. The analysis data table is a table in which components having features easily identifiable on the board are listed, and is created for each of the boards from which the defective components are detected.

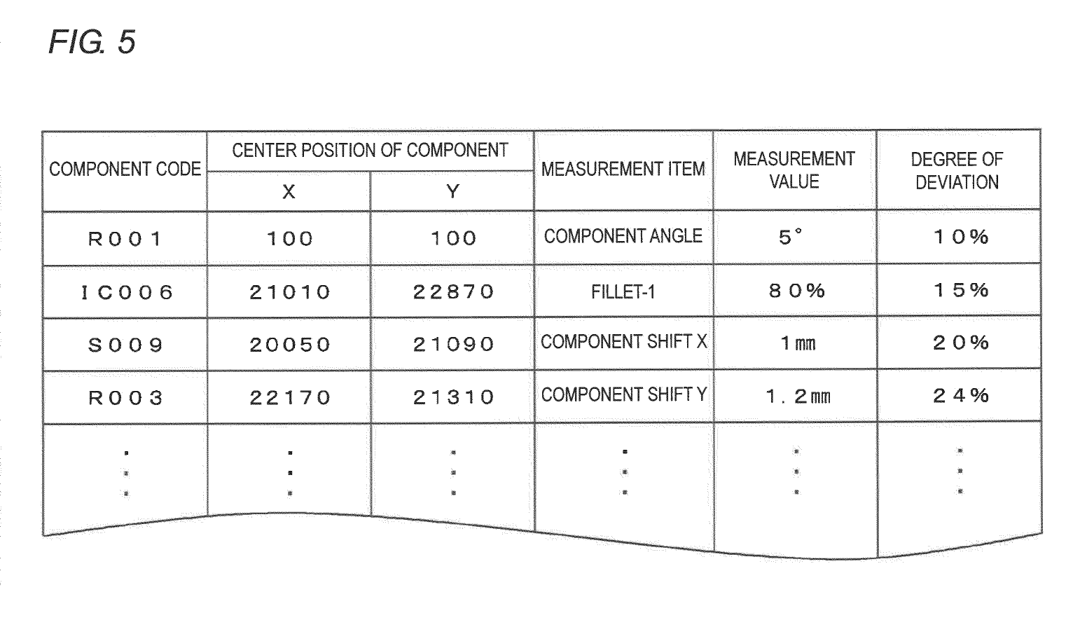

FIG. 5 shows a configuration example of the analysis data table.

The analysis data table of this example stores information of components, in which degrees of deviation of measurement values for use in the quality determination for all of the items with respect to optimum measurement values become 10% or more, among the components determined to be “non-defective” in the determination. In the illustrated example, there are stored: the identification codes (component codes) of the target components; the X- and Y-coordinates of the center portions of the target components; measurement items in which the degrees of deviation of 10% or more are obtained; measurement values and the degrees of deviation, which are obtained in measurements regarding the measurement items; and the like.

Although the X- and Y-coordinates indicating the center positions of the components are measured values, standard positional information included in the inspection standards may be extracted. Moreover, with regard to measurement items to be executed for each of the electrodes of the components, branch numbers, each indicating the electrode to which the measurement item corresponds, are imparted thereto (refer to a measurement item “fillet-1” of “IC006” in FIG. 5). By each of these branch numbers, a relative position of the electrode, which corresponds to the measurement value, in the component can be specified.

The above-described analysis data table is created in the management server 2, is stored in the inspection result database 21, is thereafter read out together with the corresponding inspection result information in response to a transmission request from the checking terminal 3, and is transmitted to the checking terminal 3.

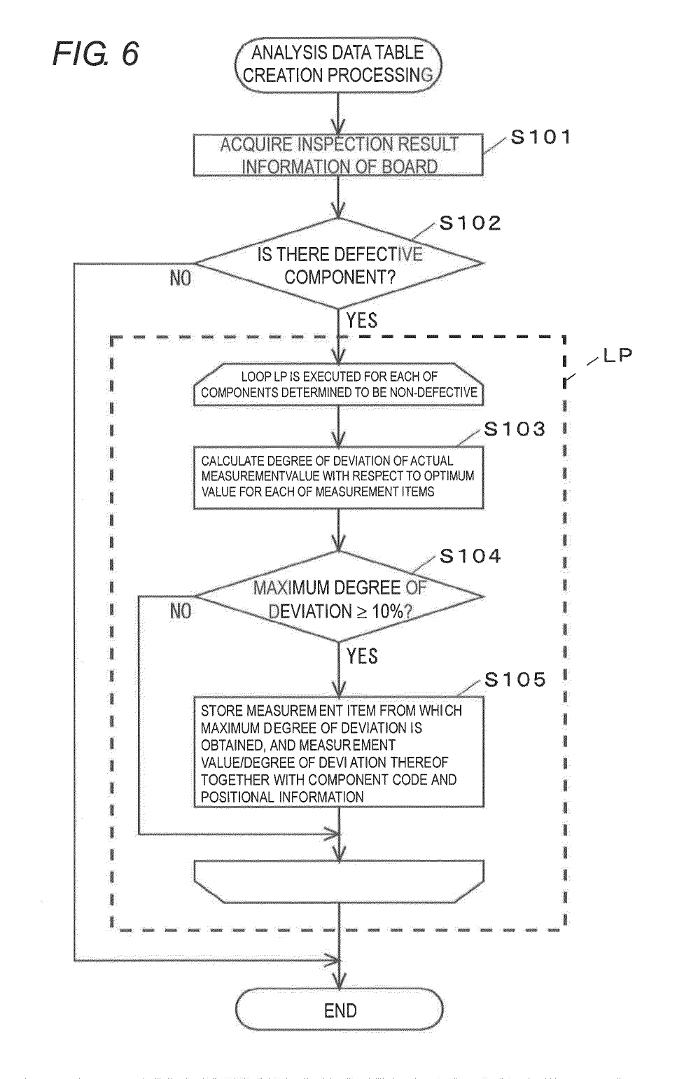

FIG. 6 shows a procedure of processing for creating the analysis data table by the management server 2.

This processing is executed by the storage processing unit 24 of the management server 2 every time the transmission of the inspection result information for the unit of the board is received from the appearance inspection device 1. However, the present invention is not limited thereto, and the processing may be executed at the time when a predetermined time has elapsed after the inspection result information is stored in the inspection result database 21.

First, in the first step S101, the inspection result information is acquired from the appearance inspection device 1, and it is checked whether the information regarding the defective component is included in this information. In the case where the defective component is not included (“NO” in step S102), the following steps are skipped, and the processing is ended.

In the case where the defective component exists (“YES” in step S102), components other than the defective component, that is, the components determined to be “non-defective” are sequentially focused, and a loop LP is executed.

In the loop LP, by using the inspection result information related to the component being focused, for each of the measurement items implemented for the target component, the degree of deviation of the actual measurement value with respect to the optimum value of the range of the measurement values determined to be non-defective is obtained by the following arithmetic operation (step S103).

$$degree of deviation = \frac{\vert measurement value - optimum value \vert}{ \begin{matrix}range of measurement values \\ determined to be non \text{-} defective\end{matrix}} \qquad [ Expression 1 ]$$

When the degrees of deviation for each of the measurement values are calculated, it is checked whether the degree of deviation, which is the maximum thereamong, is 10% or more. If the maximum degree of deviation is 10% or more (“YES” in step S104), then the measurement item from which the degree of deviation is obtained, the measurement value, and the degree of deviation are stored in the analysis data table together with the component code and positional information of the component being focused (step S105). In the case where the measurement item related to the inspection such as a floating inspection and fillet inspection of the electrode, which is implemented for each of the electrodes, becomes a target of this storage, the branch number indicating the corresponding electrode is also stored.

By the above-described processing, among the components determined to be “non-defective”, the targets are narrowed down to the components in which the degrees of deviation of the measurement values with respect to the optimum value are large, and the analysis data table is created in which the degrees of deviation and positional information of the respective target components are registered in association with each other.

Next, FIG. 7 shows a procedure of processing to be executed in the checking terminal 3 in response to the input of the board code (step S1 in FIG. 4).

First, in step S201, the transmission request is outputted to the management server 2 by using the inputted board code, whereby the inspection result information, analysis data table, and inspection standard of the target board are acquired. Although all pieces of information are not necessarily acquired with regard to the inspection standard, it is necessary to acquire information necessary to create and edit the enlarged image G of the display target, such as information for specifying the mark pattern, definition information regarding the positional alignment of the divided images, and information indicating a correspondence relationship between the respective components and the divided images (correspondence information indicating which components are included in which divided images).

In step S202, based on the inspection result information, the initial check screen is displayed on the display unit 32. Thereafter, a loop LP1 is executed every time the operator's operation of selecting the defective component is performed, whereby the determination input by the operator is received while updating the check screen.

A description will be made below in detail of the processing of the loop LP1.

First, in step S203, the inspection result information regarding the selected defective component (checking target component) is read out. In next step S204, based on the positional information in the read out information, it is specified in which divided image the selected defective component is included, and the specified divided image g0 and the eight divided images g1 to g8 near the periphery thereof are acquired by the communication with the management server 2. Moreover, in step S205, the respective divided images thus acquired are connected to one another, whereby the enlarged image G to be displayed on the area 300 is created.

In the case where the selected defective component lies across the plurality of divided images, the divided image, in which a ratio occupied by the defective component becomes the largest, is defined as the image g0 to be arranged on the center. Moreover, in the case where the respective components on the board are associated with the divided images by the individual component codes thereof, then in step S204, the image g0 to be arranged on the center may be specified based on the component code of the selected defective component.

Thereafter, steps S206 to 211 are executed for the enlarged image G.

In step S206, a search range, which takes a predetermined specific direction as a reference, is set from a starting point that is the position of the selected defective component. For example, a range extended at a predetermined angle □ from a specific direction as the center can be taken as the search range.

In step S207, a component included in the set search range is extracted from the components registered in the analysis data table. In the case where a plurality of the components are extracted, one of the components, in which the degree of deviation is the largest, is extracted.

Steps S206 and S207 are executed for a plurality of predetermined directions, whereby a plurality of the components having relatively large degrees of deviation are extracted.

When such extraction processing for all of the directions is ended (“YES” in step S208), then in step S209, the mark pattern in the enlarged image G is extracted by using the inspection standard.

In step S210, the component extracted based on the degree of deviation in step S207 is marked by the red frame RW, and the mark pattern extracted in step S209 is marked by the blue frame BW. In step S211, for the defective component in the enlarged image, the frame UW for the identification and the lines L1 and L2 which indicate the X- and Y-coordinates are set.

In the marking by the red frame RW, a range that surrounds the whole of the components as the setting targets is marked in principle; however, in the case where a large degree of deviation occurs in the measurement value in the unit of the electrode, only the electrode, from which the measurement value with the large degree of deviation is obtained, may be surrounded by the red frame RW based on the branch number of the corresponding measurement item. The red frame RW for one electrode of the IC component 103 of FIG. 3 is set by this method.

By the processing of steps S210 and S211, the enlarged image is edited to an image of a state where the selected defective component and the components with the large degrees of deviation and the mark patterns, which are located on the periphery of the defective component, are marked by colors different from one another. In step S212, the display of the check screen is updated by this enlarged image after being edited. Although a detailed procedure is omitted, in this update of the display, the lines m1 and m2 for the position identification are also set on the map image MP, and the image and the inspection result information are respectively displayed on the areas 301, 302, and 313 shown in FIG. 2.

Further, in step S213, the input (step S6 in FIG. 4) of the determination data (OK or NG) by the operator is received, and the inputted determination data is added to the inspection result information of the selected defective component.

The loop LP1 is executed for all of the components determined to be defective, whereby the determination data based on the inspection result information of the components determined to be defective in the automatic appearance inspection are added. When all of the defective components are processed, in the last step S214, an inspection result information file, in which addition of the determination data is completed, is transmitted to the management server. In this manner, the processing is ended.

In the above-described example, the determination input of the quality by the operator is always performed, and the inputted determination data are added to the inspection result information. However, in place of this, the inspection result in the area 313 in the check screen may be rewritten only when the operator determines that the selected component is non-defective.

In many cases, a production line of the component-mounted boards is automated in a similar way to the appearance inspection. However, an application amount of cream solder and a heating temperature in a reflow step do not become uniform, and the mounting of the components by the mounter does not proceed uniformly, either. Therefore, even in the same type of components, variations occur in the positions and attitudes of the components, the shapes and sizes of the fillets, and the like. Similar variations are also seen in states of the components to be mounted on the same places of the same type of boards.

Each piece of the measurement processing in the appearance inspection is performed on the visually recognizable region. Accordingly, it is highly possible that, in a region from which a measurement value largely different from the optimum value is obtained, a feature remarkably different from those in the other regions of the same type may occur in the appearance that has become the target of the measurement. Focusing on this point, in the above embodiment, the component, in which the degree of deviation of the actual measurement value with respect to the optimum measurement value is large, is extracted as the target to be marked by the red frame RW, and accordingly, it becomes possible to mark the component having such a feature distinguishable by the naked eye.

Moreover, in accordance with the processing of FIG. 7, the marking by the red frames RW is set in the plurality of orientations with the defective component as the checking target taken as a reference, and in addition, the mark patterns are explicitly illustrated by the blue frames BW at the plurality of spots on the periphery of the defective component. Accordingly, based on the appearance features and distribution of the marked spots, the operator can easily find the spots, which correspond thereto, on the actual board. Hence, the defective component as the checking target can be specified without mistake, and the quality thereof can be determined.

Note that such search directions in the case of extracting the components with large degrees of deviation are not particularly limited. However, the search directions are desirably set so that the checking target component can be surrounded by the extracted components. For example, in the case of the example of FIG. 3, the search is executed in three directions with respect to the defective component, which are directly above direction, a diagonally lower-right direction, and a diagonally lower-left direction. Moreover, the search may be performed in four directions, i.e., up, down, left, and right directions with respect to the checking target component, and furthermore, may be performed in eight directions in total, which are obtained by adding diagonally upper directions and diagonally lower directions to the four directions.

Moreover, in the procedure shown in FIG. 7, for each of the search ranges, one component having the maximum degree of deviation in the range is extracted. However, the present invention is not limited thereto, and all of the components in which the degrees of deviation exceed a predetermined value may be extracted. Moreover, the components to which the red frames RW are added may be selected under conditions where the components in which the degrees of deviation exceed the predetermined value are extracted from the whole of the enlarged image as a target without setting the search directions, and some of the components extracted therefrom are distributed so as to surround the checking target component. Moreover, in the case where the degrees of deviation of the extracted components largely exceed the minimum value (10%) taken as the condition of the extraction, the number of components to be extracted by the search may become one.

The method of the marking is not limited to the frames; however, marking in a mode in which the features of the marking targets in the image cannot be checked must be avoided.

Moreover, the targets to be marked by the red frames RW are not limited to the components, and for example, solder balls detected in a foreign object inspection and bridges extracted in a bridge inspection may be taken as the marking targets. For example, solder balls and bridges, in which sizes measured by the inspections exceed predetermined values, can be easily recognized even by the naked eye, and accordingly, are suitable as the marking targets of the red frames RW.

A description will be made of other modification examples regarding the above system.

First, in the above embodiment, the board codes of the boards as the checking targets are inputted, whereby the variety of information including the images used in the inspection is read out, and the check screen is set. However, in the case where the boards inspected in the appearance inspection device 1 sequentially flow to the checking terminal 3 in the order of inspection, and the boards to be checked can be uniquely specified, the information may be transmitted to the checking terminal 3 in accordance with the order of the inspection without inputting the board codes. In this case, the information may be directly transmitted from the appearance inspection device 1 to the checking terminal 3 without passing through the management server 2.

Moreover, the checking targets are not limited to the defective components, and components, in which the degrees of deviation in the measurement values are large although the components are determined to be non-defective, may be included in the checking targets.

The function to read out the image in the area including the checking target component from the image database 22 and to edit the image to the enlarged image G to which the marking is performed may also be provided in the management server 2 without being limited to the checking terminal 3. In this case, in the checking terminal 3, there are set: a function to receive, from the management server 2, supply of the information of the check screen 30 including the enlarged image G, and to display the information on the display unit 32; and a function to receive the input of the determination data by the operator, and to transmit the determination data to the management server 2.

In the above embodiment, the image is read out from the image database 22, the enlarged image G is created, and thereafter, the spots to which the red frames RW and the blue frames BW are added are specified. However, the order of these pieces of the processing may be reversed, and the respective pieces of processing may be implemented in parallel.

In the above embodiment, the divided image including the checking target component is specified, and the enlarged image G is created by this image and the images near the periphery 8 thereof. However, the present invention is not limited thereto, and based on the positional information of the checking target component, an area with a predetermined size, in which the component is centered, may be specified, and an image of the area specified from the entire image of the board may be cut out.

Moreover, a scaling factor of the enlarged image G is not uniformly limited. In the case where the component with a large degree of deviation, to which the red frame RW is added, is located near the checking target component, the scaling factor may be increased, and in the case where the component to which the red frame RW is added is located far from the checking target component, the scaling factor may be reduced. For example, it is considered that a distance between the checking target component and a component located closest to the checking target component among the components extracted as the components with large degrees of deviation, and the scaling factor of the enlarged image G is decided so that the scaling factor of the enlarged image G can be inversely proportional to this distance.

Alternatively, two scaling factors may be set, i.e., a standard scaling factor at which the entire image formed of the nine divided images is displayed; and a magnification scaling factor larger than the standard scaling factor. In the case where a predetermined number or more of the components with large degrees of deviation are included in a display range by the magnification scaling factor, the magnification scaling factor may be employed, and otherwise, the standard scaling factor may be employed. Moreover, such switching of the scaling factors is not limited to two stages, and three stages or more may also be employed.

In the above embodiment, the boards completed through the final step are taken as the targets of the visual check. However, also at a stage where an intermediate step is ended, the visual check operation can be performed on boards in which the automatic appearance inspection in that step is ended, and in addition, similar marking images are displayed, whereby the check operation can be assisted.

Finally, the inspection targets to which the present invention is applied are not limited to the component-mounted board, and the present invention can also be applied to other structures, each of which including a plurality of target regions for inspection by the automatic appearance inspection, and in which visually recognizable intrinsic features may occur on the appearances of these regions.

What is claimed is:

1. A system for assisting a visual check operation of an inspection result, the system being a system for assisting an operation of checking a state of at least one inspection target region of an inspection target having a plurality of regions to which an automatic appearance inspection using an image is performed, the operation being performed by a method of visually recognizing an actual inspection target, the system comprising:
an image storage unit configured to store an image of the inspection target, the image being created by imaging for the automatic appearance inspection;
a measurement data storage unit configured to store measurement data obtained by measurement processing of the automatic appearance inspection in association with positional information of a target region measured by the measurement processing;
an image reading unit configured to read out an image of an area from the image storage unit based on positional information or identification information of a checking target region, the area including the checking target region and corresponding to a part of the inspection target;
a feature region extraction unit configured to analyze the measurement data stored in the measurement data storage unit in association with the positional information included in the area corresponding to the image read out by the image reading unit, and extract one or more feature regions which have intrinsic features individually visually recognizable and are distributed near the checking target region;
an image editing unit configured to edit the image read out by the image reading unit to a state where the respective feature regions and the checking target region in the image are marked in modes different from each other; and
a display unit configured to display the image edited by the image editing unit.

2. The system for assisting a visual check operation of an inspection result according to claim 1, wherein, by using, as a key, a degree of deviation of a measurement value obtained in the measurement processing of the automatic appearance inspection with respect to an optimum measurement value, the feature region extraction unit extracts a region with a relatively large degree of deviation among inspection target regions other than the checking target region, the inspection target regions being included in the area.

3. The system for assisting a visual check operation of an inspection result according to claim 1, wherein measurement for detecting a foreign object located at a place other than the inspection target region is included in the measurement processing of the automatic appearance inspection, and
the feature region extraction unit extracts, as the feature region, a spot where measurement data indicating the foreign object is obtained near the checking target region in the area.

4. The system for assisting a visual check operation of an inspection result according to claim 1, further comprising:
a mark pattern storage unit that stores information for specifying a mark pattern set as a mark in the automatic appearance inspection commonly to similar types of the inspection target, wherein
the image editing unit specifies a place of the mark pattern included in the area based on the information stored in the mark pattern storage unit, and edits the image so that the specified place is marked in a mode different from that of at least the checking target region.

5. The system for assisting a visual check operation of an inspection result according to claim 1, wherein
the system includes a server that receives, by communication with an appearance inspection device, inspection result information including the image used in the appearance inspection and the measurement data, and includes a terminal device having a display unit for the check operation, and
at least the image storage unit and the measurement data storage unit are provided in the server, and the display unit of the terminal device functions as the display unit.

6. A device for assisting a visual check operation of an inspection result, the device being a device for assisting an operation of checking a state of at least one inspection target region of an inspection target having a plurality of regions to which an automatic appearance inspection using an image is performed, the operation being performed by a method of visually recognizing an actual inspection target, the device comprising:
an image reading unit configured to read out an image of an area from an image storage unit, in which an image of the inspection target is stored, based on positional information or identification information of a checking target region, the area including the checking target region and corresponding to a part of the inspection target;
a feature region extraction unit configured to read out and analyze measurement data, the measurement data being associated with the positional information included in the area corresponding to the image read out by the image reading unit, from a measurement data storage unit configured to store measurement data obtained by measurement processing of the automatic appearance inspection in association with positional information of target region measured by the measurement processing, and extract one or more feature regions which have intrinsic features individually visually recognizable and are distributed near the checking target region;
an image editing unit configured to edit the image read out by the image reading unit to a state where the respective feature regions and the checking target region in the image are marked in modes different from each other; and
an output unit configured to output image data of the image edited by the image editing unit such that the image data is displayed.

7. A method for assisting a visual check operation of an inspection result, the method being a method for assisting an operation of checking a state of at least one inspection target region of an inspection target having a plurality of regions to which an automatic appearance inspection using an image is performed, the operation being performed by a method of visually recognizing an actual inspection target, the method comprising the steps of:
storing an image of the inspection target, the image being created by imaging for the automatic appearance inspection, in an image storage unit in response to the automatic appearance inspection, and storing measurement data, which is obtained by measurement processing in the automatic appearance inspection, in a measurement data storage unit in association with positional information of a target region measured by the measurement processing;
reading out an image of an area from the image storage unit based on positional information or identification information of a checking target region, the area including the checking target region and corresponding to a part of the inspection target;
analyzing measurement data, the measurement data being stored in the measurement data storage unit in association with positional information included in the area corresponding to the image read out from the image storage unit, and extracting one or more feature regions which have intrinsic features individually visually recognizable and are distributed near the checking target region; and
editing the image read out from the image storage unit to a state where the respective feature regions and the checking target region in the image are marked in modes different from each other, and displaying the edited image.

8. The system for assisting a visual check operation of an inspection result according to claim 2, wherein measurement for detecting a foreign object located at a place other than the inspection target region is included in the measurement processing of the automatic appearance inspection, and
the feature region extraction unit extracts, as the feature region, a spot where measurement data indicating the foreign object is obtained near the checking target region in the area.
